(19) United States
(12) Patent Application Publication
(10) Pub. No.: US 2010/0135546 A1
(43) Pub. Date: Jun. 3, 2010

(54) LANDMARK GUIDES FOR REGISTRATION OF MULTI-MODALITY MEDICAL IMAGES

(75) Inventor: Balazs Peter Cziria, Pest megye (HU)

Correspondence Address: DEAN D. SMALL;THE SMALL PATENT LAW GROUP LLP, 225 S. MERAMEC, STE. 725T, ST. LOUIS, MO, 63105, US

(73) Assignee: General Electric Company, Schenectady, NY (US)

(21) Appl. No.: 12/324,970

(22) Filed: Nov. 28, 2008

(51) Int. Cl. G06T 7/00

(52) U.S. Cl. 382/128

(57) ABSTRACT

Systems, methods and apparatus are provided through which in some implementations a graphical user interface and flexible workflow in specifying landmarks in medical image volumes reduces effort in aligning different medical images of the volume into a same geometrical position and shape.

### FIELD

This invention relates generally to three-dimensional imaging, and more particularly to use of landmarks in registration or landmark based registration.

### BACKGROUND

Registration of images and the use of landmarks in identifying points of interest in imaged subject are conventional. Image registration is the process of transforming the different sets of data into one coordinate system. Registration is necessary in order to be able to compare or integrate the data obtained from different measurements.

Medical image registration (e.g. for data of the same patient taken at different points in time) often additionally involves elastic (or nonrigid) registration to cope with deformation of the subject (due to breathing, anatomical changes, etc.). Nonrigid registration of medical images can also be used to register a patient's data to an anatomical atlas, such as the Talairach atlas for neuroimaging.

Conventional registration tools use a linear process flow, requiring the user to perform steps one by one in a strict order. Conventional tools perform registration on a limited set of medical image series at and only manage pairs of landmarks.

### BRIEF DESCRIPTION

The above-mentioned shortcomings, disadvantages and problems are addressed herein, which will be understood by reading and studying the following specification.

In one aspect, a method to manage landmarks in medical images, the method comprising using a processor to perform loading a plurality of three-dimensional images into a memory specifying at least one landmark position on one image of the plurality of three-dimensional images in the memory, wherein specifying each of the at least one landmark position further comprises receiving into the memory from a user an indication of a position on an image from the graphical user interface and if the landmark position is defined on the image for the current landmark, displaying a table on the graphical user interface, the table having one row of each of the images in the plurality of three-dimensional images and having a column for each of the at least one landmark and having a check mark at a row of the one image and in the column of the at least one landmark where the given landmark is defined on the given image. Updating relative positions of the plurality of three-dimensional images in the memory according to each of the at least one landmark position and a specified reference image and a registration image in response to specifying a landmark position.

In another aspect, a computer-accessible medium having executable instructions to managing landmarks in medical images, the executable instructions capable of directing a processor to perform loading a plurality of three-dimensional images into a memory, specifying at least one landmark position on one image of the plurality of three-dimensional images in the memory, updating relative positions of the plurality of three-dimensional images in the memory according to each of the at least one landmark position and a specified reference image and a registration image in response to the specification of a landmark position.

In yet a further aspect, a method to manage landmarks in medical images, the method including using a processor to perform receiving an indication of a position on a graphical user interface, displaying a table on the graphical user interface, the table having one row of each of a plurality of three-dimensional images and having one column for each of a plurality of landmarks and having a visual indicator at a row of a particular image of the plurality of three-dimensional images and in the column of a particular landmark of the plurality of landmarks.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a diagram illustrating a system-level overview of an implementation.

FIG. 2 is a flowchart of a method to manage landmarks in medical images, according to an implementation;

FIG. 3 is a flowchart of a method of specifying one or more landmark position(s), according to an implementation;

FIG. 4 is a flowchart of a method of receiving from the user an indication of a position on a graphical user interface, according to an implementation;

FIG. 5 is a flowchart of a method to manage one or more landmarks in medical images, according to an implementation;

FIG. 6 is a diagram of a landmark table and a graphical user interface (GUI) landmark tool, according to an implementation;

FIG. 7 is a diagram of a progression of a landmark table, according to an implementation;

FIG. 8 is a block diagram of a hardware and operating environment in which different implementations can be practiced; and

FIG. 9 is a block diagram of an overview of an X-ray system configured to improve X-ray imaging operations.

### DETAILED DESCRIPTION

In the following detailed description, reference is made to the accompanying drawings that form a part hereof, and in which is shown by way of illustration specific implementations, which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, implementations of methods are described. In the third section, graphical user interface implementations are described. In the fourth section, hardware and operating environment in conjunction with which implementations may be practiced are described. Finally, in the fifth section, a conclusion of the detailed description is provided.

### System Level Overview

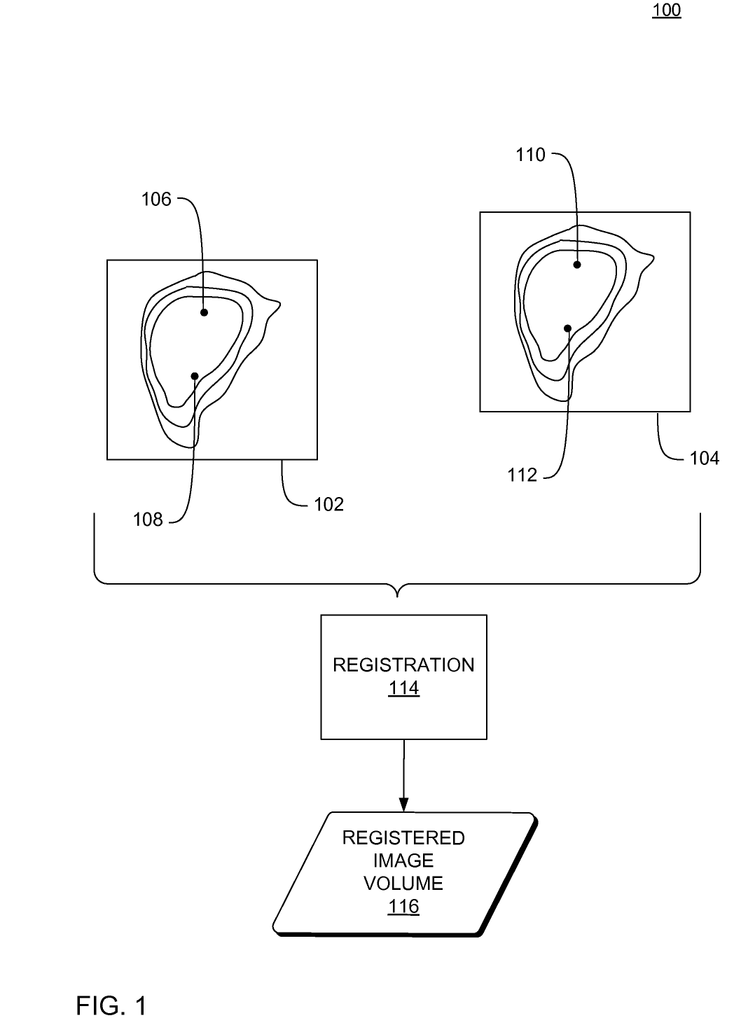

FIG. 1 is a block diagram of an overview of a system 100 to manage landmarks in three-dimensional medical images.

System 100 includes two or more images 102 and 104. Landmark positions 106, 108, 110 and 112 are specified at locations on the images 102 and 104. The landmarks are specified in any order in relation to each other. The flexible order of landmark specification reduces the amount of time that an operator needs to spend in landmark specification.

A landmark position (or simply “position”) is a 3D coordinate on a given image. A landmark position usually depicts an anatomically well-defined point or an artificially created point in the patient body (like metal markers). The image that this coordinate is defined is important because a coordinate is not valid (the coordinate may have no meaning) on any other image.

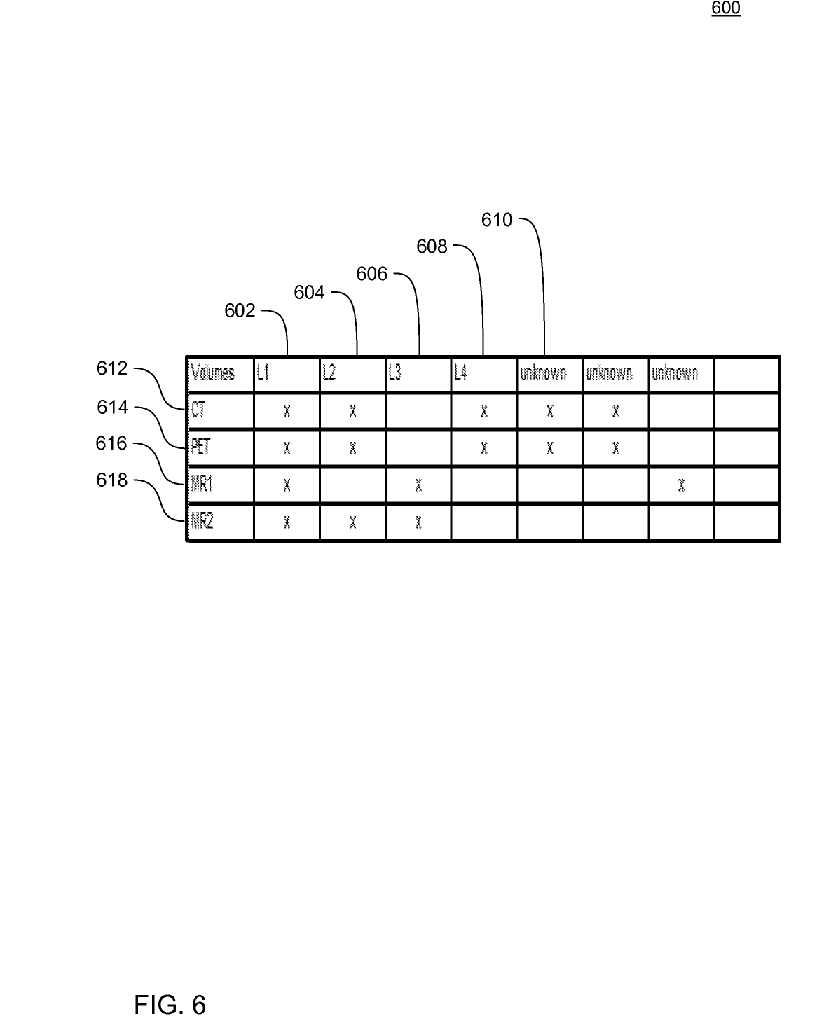

A landmark is a collection of landmark positions on different images, in a way that all the positions correspond to the same anatomical location across the images (e.g. the middle of the right eye on the CT, MR and PET scan that has been loaded.) For example, a column in the table of FIG. 6 corresponds to exactly one landmark, and may contain landmark positions for any image. If it contains a landmark position for a given image, a checkmark is shown in the table in the row of the image. It might be that a given anatomical point is not observable on a given image or cannot be defined for some reasons or just simply has not been defined, then for that image no landmark position is defined for that landmark, hence no checkmark shown in the column of the landmark in the row of the image. The specification of landmark positions at block 204 can partially defined for images with the plurality of 3D image. For example, the landmark positions can be specified only on two images out of a plurality of four 3D images, and possibly as few as one image, which is particularly useful when the landmark position belongs to an unknown landmark, so there is a chance that the unknown landmark has a pair among the others, e.g. the unknown landmark is the result of automatic BB detection on the reference image and an other unknown landmark from the automatically detected BBs on the registration image indicates the same anatomical position and will be paired with the former unknown landmark by the registration process.

After specification of landmarks, the images 102 and 104 are registered 114, resulting in a registered image volume.

While the system 100 is not limited to any particular image, landmark or registration. For sake of clarity, simplified images, landmarks and registration are described.

### Method Implementations

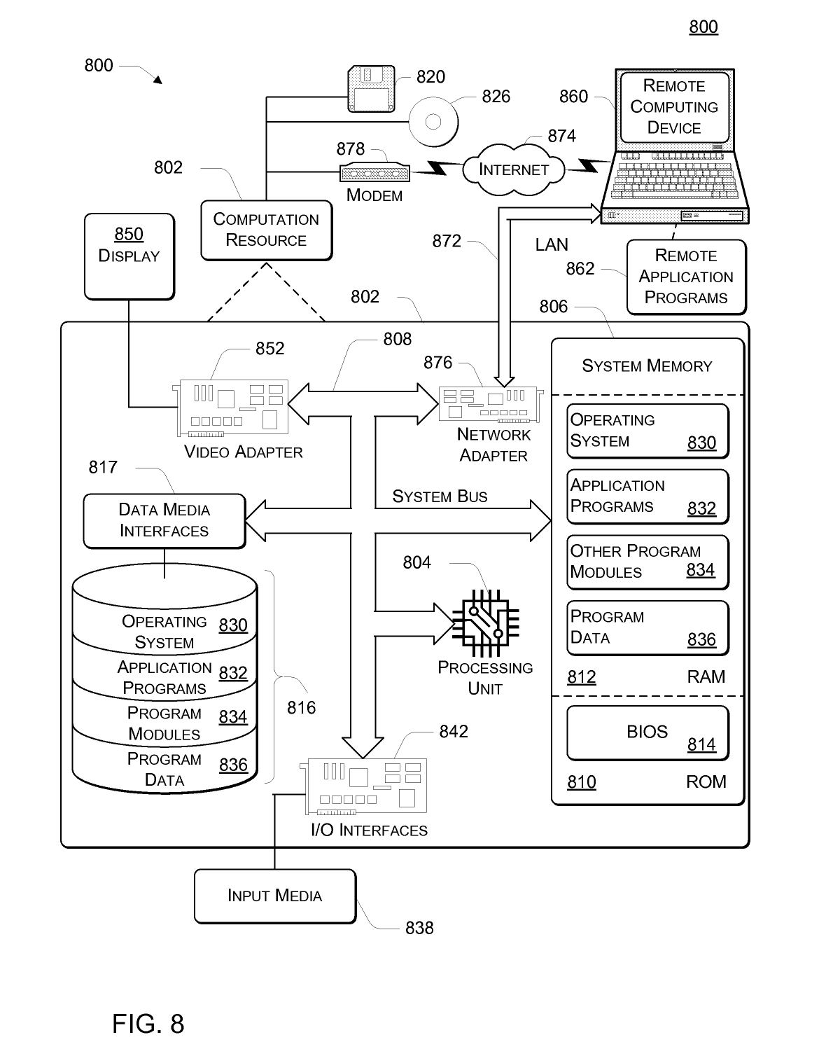

In the previous section, a system level overview of the operation of an implementation is described. In this section, the particular methods of such an implementation are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-500 are performed by a program executing on, or performed by firmware or hardware that is a part of, a computer, such as general computer environment 800 in FIG. 8.

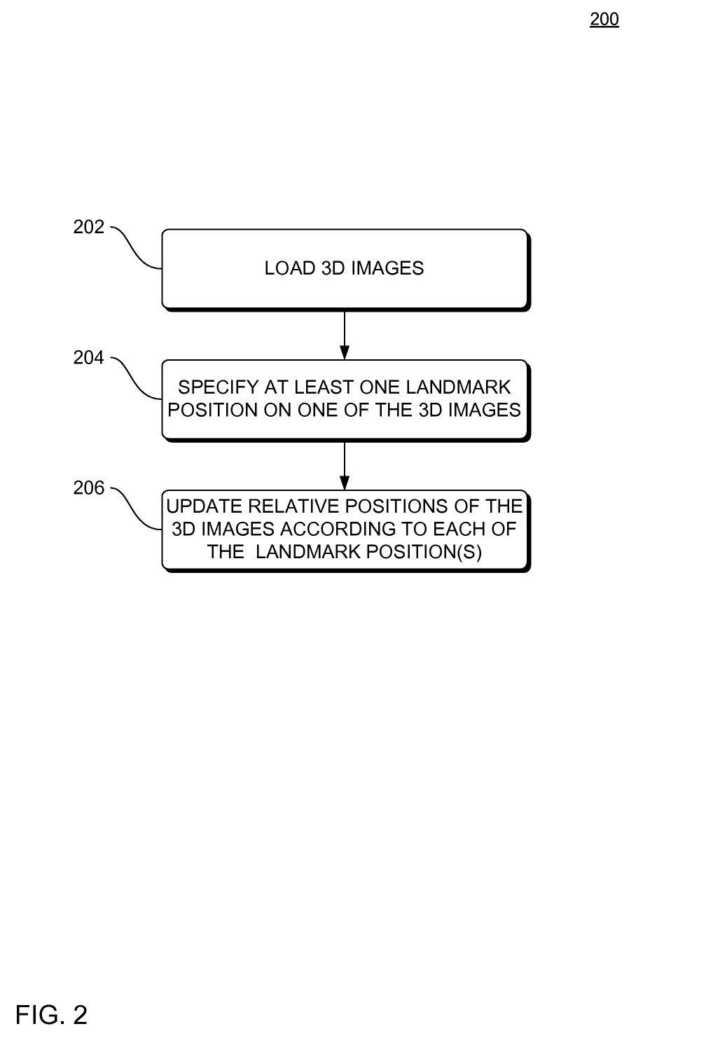

FIG. 2 is a flowchart of a method 200 to manage landmarks in medical images, according to an implementation. Method 200 provides a flexible method of landmark specification.

Method 200 includes loading or storing a plurality of three-dimensional (3D) images, at block 202. In some implementations, the plurality of 3D images have mixed modalities; two or more different modalities. For example, the modalities can include two or more of computed tomography (CT), positron emission tomography (PET), magnetic resonance (MR), X-ray and single photon emission computed tomography, or other 3D medical image. In some implementations, the plurality of 3D images has mixed acquisition dates, in which the images were acquired at different dates. In some further implementations, the images are a series of acquisitions over a range of dates.

Method 200 also includes specifying one or more landmark position(s) on one image of the plurality of 3D images, at block 204. In some implementations, the landmark position(s) are positions of metal markers (e.g. metal BBs) attached to an imaged patient. In some implementations, the landmark position(s) are an anatomically well-defined point identified by an imaging technician. In some implementations, some of the landmark position(s) are positions of metal markers (e.g. metal BBs) attached to an imaged patient and some of the landmark position(s) are an anatomically well-defined point identified by an imaging technician.

Method 200 also includes updating relative positions of the plurality of 3D images, at block 206. The updating is performed according to 1) each of the one or more landmark(s) 2) a specified reference image and according to 3) a registration image. The updating at block 206 is performed in response to the specification of one or more landmark(s) at block 204. The updating at block 206 provides simultaneous and flexible definition of multiple landmarks and thus reduces the manual effort required in arranging the 3D medical images into the same geometrical position and shape. Method provides flexible workflow because where the order of placement of landmarks is free of any rules and restrictions. The updating at block 206 includes registering the plurality of 3D images.

Method 200 imposes no limits on how many landmark points or any order that the landmark points can be placed on the 3D medical images and imposes no limits on the number of medical images that can be processed.

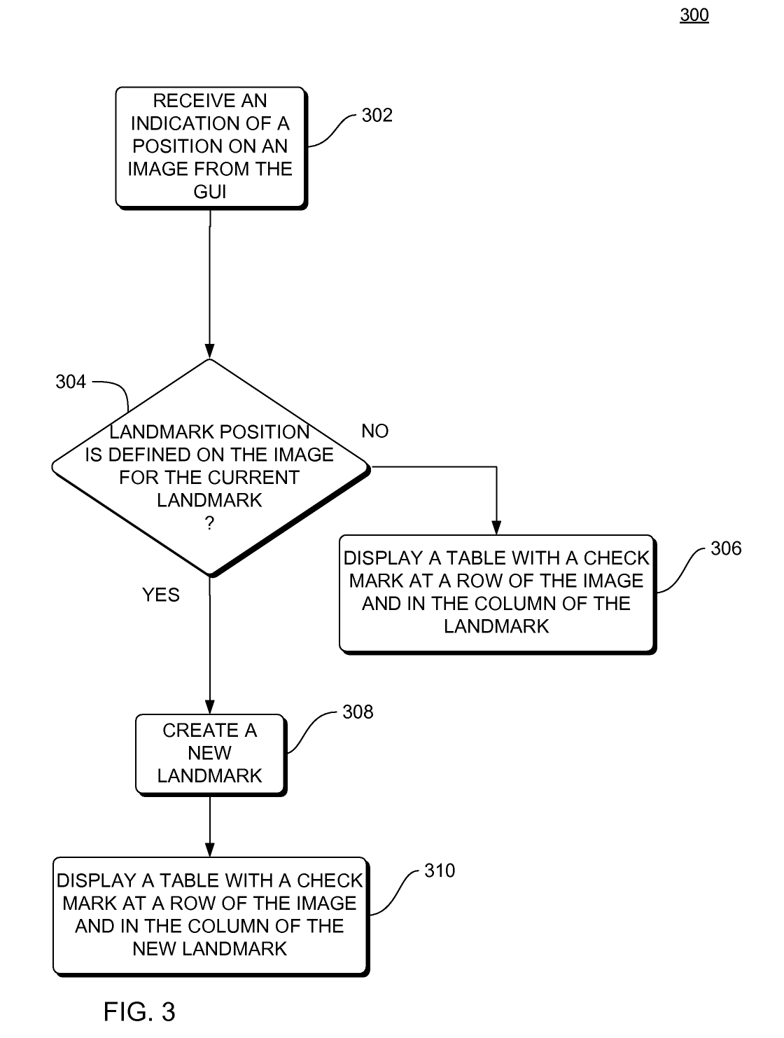

FIG. 3 is a flowchart of a method 300 of specifying one or more landmark position(s), according to an implementation. Method 300 includes receiving an indication of a position on an image from the graphical user interface (GUI) from a user, at block 302 in response to a user clicking a mouse button or pressing a specific key on the keyboard while the mouse pointer is over a location on the appropriate image or in response to the user using some other method to specify a position on the image. The actions of block 302 are described in greater detail in method 400.

If no landmark position has been defined on the image for the current landmark (that is, no checkmark in the table in the row of the image and in the current column) then this landmark position is defined as the initial landmark position and, as a consequence, a checkmark will appear in the table in the row of the image and in the column of the current landmark, at block 306.

If a landmark position has already been defined for the current landmark and the image, then a new landmark is created at block 308, a new column is displayed in the table, the landmark position of this new landmark is specified on the image and a checkmark is displayed in the table in the row of the image and column of the landmark, at block 310.

One example of a workflow involving methods 200 and 300, starts with loading two cranial scan images, a computed tomography (CT) image and a magnetic resonance (MR) image, at block 202. Next, the CT image is selected as the reference image and the MR image is selected as the registering image.

Then, an empty landmark is created, at block 204, becoming the current one landmark, designated L1 for the CT image. In the CT image, the user uses a mouse to point to the middle of the right eye and the user presses a key, at block 302.

As the current L1 landmark for the CT image is empty at this point in the workflow, hence L1 contains no position for the CT image, at block 304. At this point in the workflow, the middle of the right eye position of the CT image is recorded as L1, at block 308.

Having only one landmark position recorded, no corresponding pairs of landmark positions are yet recorded, thus block 206 is not yet performed.

Thereafter, in the MR image, the user uses a mouse to point to the middle of the right eye on the MR image, at block 302.

As the current L1 landmark for the MR image is empty at this point in the workflow, hence L1 contains no position for the MR image, at block 304. At this point in the workflow, the middle of the right eye position of the MR image is recorded into L1, at block 306.

Subsequently, the relative positions of CT and MR image are updated at block 206 by registering the MR image with the CT image, so that the positions for the right eye will line up in the MR and the CT image.

Then in the CT image, the user uses a mouse to point to the middle of the left eye and the user presses a key, at block 302.

As the current L1 landmark for the CT image is not empty at this point in the workflow, a new landmark is created, designated as L2, and the middle of the left eye position of the CT image is recorded as L2, at block 308.

At this point in the workflow, L1 has exactly 2 positions (one for CT at the center of the right eye, and one for MR at the center of the right eye) and L2 has exactly one position (the left eye center).

Thereafter in the MR image, the user uses a mouse to point to the middle of the left eye on the MR image, at block 302.

As the current L2 landmark for the MR image is empty at this point in the workflow, hence L2 contains no position for the MR image, at block 304. At this point in the workflow, the middle of the left eye position of the MR image is recorded as L2, at block 306.

At this point in the workflow, two corresponding pairs of landmark positions are stored. Subsequently, the relative positions of the CT and the MR image are updated at block 206 by registering the MR image with the CT image, so that the positions for the left eye will line up in the MR and the CT image. Thus the relative positions of the CT and MR images of both the L1 positions (right eye) and L2 positions (left eye) will align or at the very least, the best translation and rotation of alignment will be achieved (e.g. in which the CT right eye to MR right eye and CT left eye to MR left eye are aligned as close as possible).

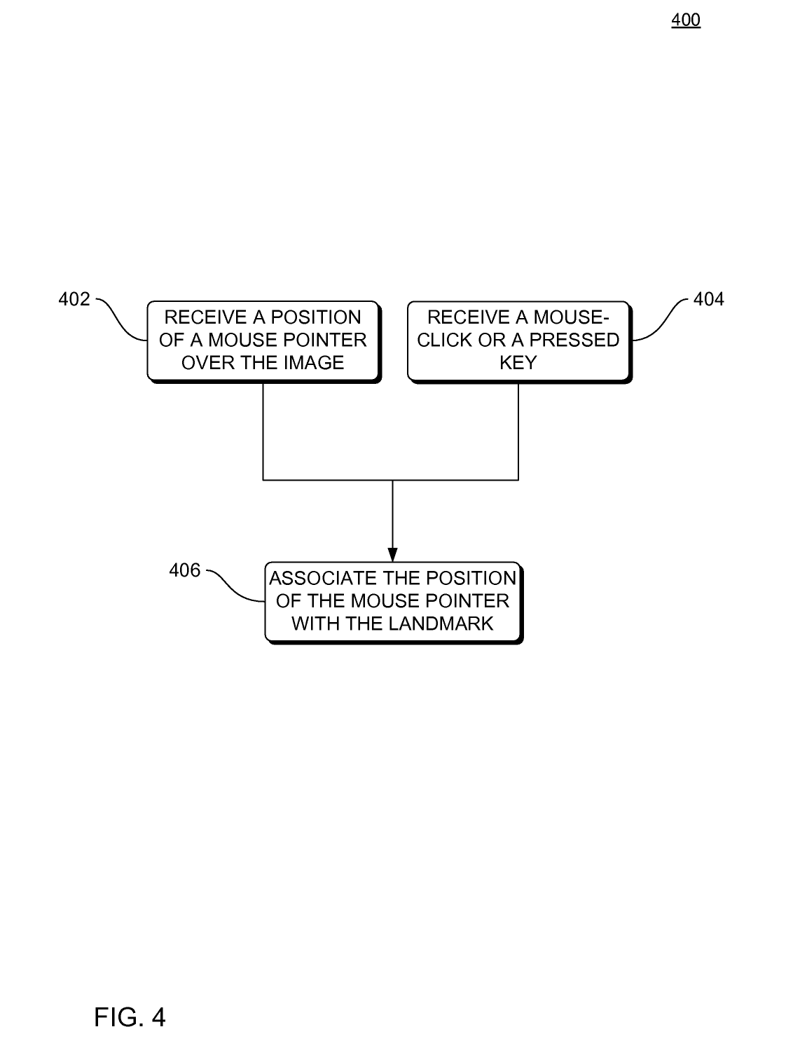

FIG. 4 is a flowchart of a method 400 of receiving from the user an indication of a position on a graphical user interface, according to an implementation.

Method 400 includes receiving from the user a position in the image, at block 402 and receiving from the user an indication of a click of a mouse button or a pressed key at block 404. For a given position, the user can use either a mouse click to indicate the position in the image, in which case the mouse position at the moment of the click is received as the position in the image, or the user can press a key to indicate the position in the image, in which case the mouse position or the position of some other indicator at the moment of the key press is taken as the position in the image.

Method 400 also includes associating the position in the image with the landmark, at block 406.

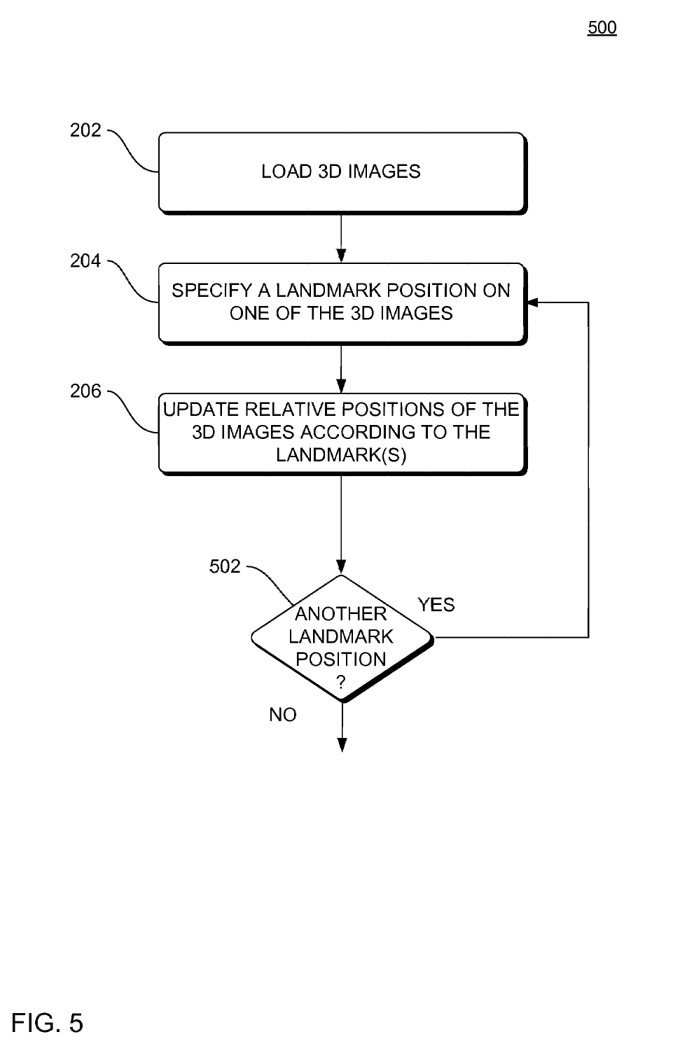

FIG. 5 is a flowchart of a method 500 to manage one or more landmarks in medical images, according to an implementation. In method 500, the specifying of the landmark position(s) at block 204, updating relative positions at block 206. Block 502 addresses a notable feature, which is that a user can specify the positions of different landmarks in any order, e.g. specify the positions on the CT for L1 and L2 landmark and then the positions on the PET for L1 and L2. In that example L1 is not finished before specifying the positions for L2, and this is permitted.

After having processed a landmark, at blocks 202, 204, 206 and 502 method 500 includes determining whether or not another landmark position can be processed, at block 502. If another landmark is available to be processed, the method continues at block 204. Otherwise, when no more landmarks are available to be processed, the method 500 ends.

In some implementations, methods 200-500 are implemented as a computer data signal embodied in a carrier wave, that represents a sequence of instructions which, when executed by a processor, such as processing units 804 in FIG. 8, cause the processor to perform the respective method. In other implementations, methods 200-500 are implemented as a computer-accessible medium having executable instructions capable of directing a processor, such as processing units 804 in FIG. 8, to perform the respective method. In varying implementations, the medium is a magnetic medium, an electronic medium, or an optical medium.

### Graphical User Interface Implementations

FIG. 6 is a diagram of a landmark table 600, according to an implementation. In table 600, landmarks 602, 604, 606 and 608 are displayed with the loaded medical images. The landmarks positions are grouped into columns 602, 604, 606 and 608 by landmark identifiers (L1, L2, L3 and L4) or without identifiers (Ex. 610). A check mark for an image illustrates a landmark position for a given landmark (e.g. column 610 illustrates two landmark positions for image 612 and 614 respectively. After a user defines the first landmark associated to a medical image set a new empty landmark column is created.

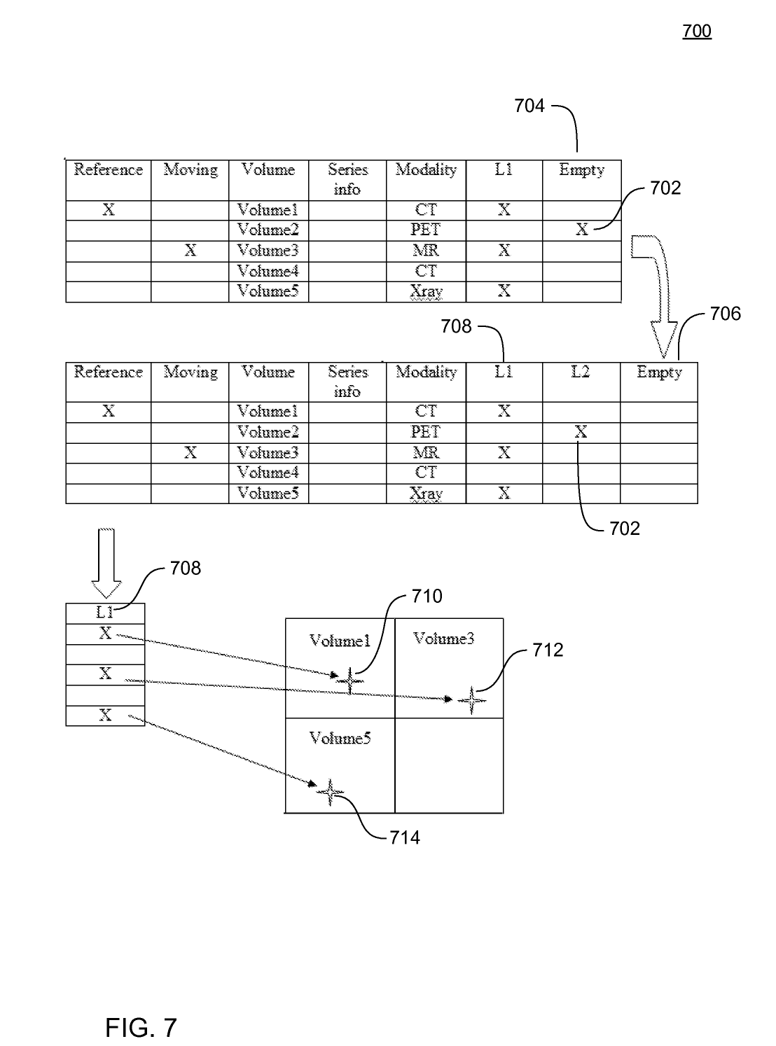

FIG. 7 is a diagram of a progression of a landmark table 700, according to an implementation. In the progression of a landmark table 700, when a landmark position 702 is defined in an empty column 704, a new empty landmark column 706 is defined.

When a user clicks on a landmark identifier 708. The landmark positions 710, 712 and 714 of the landmark identifier 708 are displayed on the images where the landmark positions 710, 712 and 714 were defined before.

### Hardware and Operating Environment

FIG. 8 is a block diagram of a hardware and operating environment 800 in which different implementations can be practiced. The description of FIG. 8 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

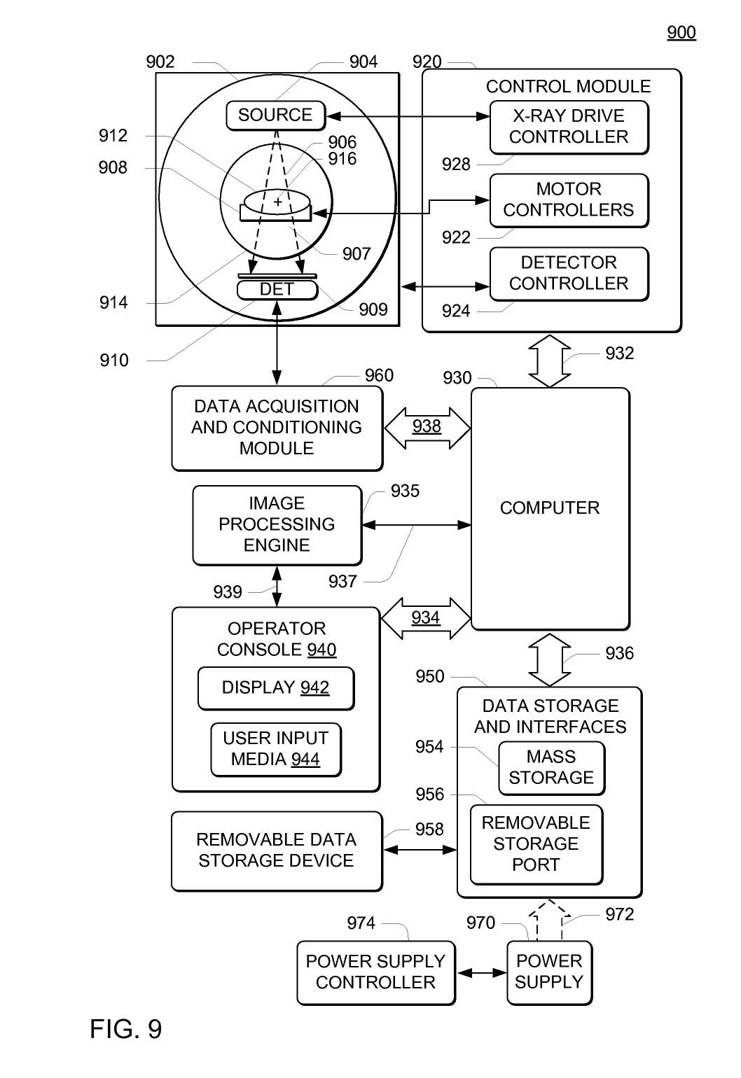

FIG. 8 illustrates an example of a general computer environment 800 useful in the context of the environment of FIG. 9, in accordance with an implementation of the disclosed subject matter. The general computer environment 800 includes a computation resource 802 capable of implementing the processes described herein. It will be appreciated that other devices can alternatively used that include more components, or fewer components, than those illustrated in FIG. 8.

The illustrated operating environment 800 is only one example of a suitable operating environment, and the example described with reference to FIG. 8 is not intended to suggest any limitation as to the scope of use or functionality of the implementations of this disclosure. Other well-known computing systems, environments, and/or configurations can be suitable for implementation and/or application of the subject matter disclosed herein.

The computation resource 802 includes one or more processors or processing units 804, a system memory 806, and a bus 808 that couples various system components including the system memory 806 to processor(s) 804 and other elements in the environment 800. The bus 808 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 806 includes nonvolatile read-only memory (ROM) 810 and random access memory (RAM) 812, which can or can not include volatile memory elements. A basic input/output system (BIOS) 814, containing the elementary routines that help to transfer information between elements within computation resource 802 and with external items, typically invoked into operating memory during start-up, is stored in ROM 810.

The computation resource 802 further can include a non-volatile read/write memory 816, represented in FIG. 8 as a hard disk drive, coupled to bus 808 via a data media interface 817 (e.g., a SCSI, ATA, or other type of interface); a magnetic disk drive (not shown) for reading from, and/or writing to, a removable magnetic disk 820 and an optical disk drive (not shown) for reading from, and/or writing to, a removable optical disk 826 such as a CD, DVD, or other optical media.

The non-volatile read/write memory 816 and associated computer-readable media provide nonvolatile storage of computer-readable instructions, data structures, program modules and other data for the computation resource 802. Although the exemplary environment 800 is described herein as employing a non-volatile read/write memory 816, a removable magnetic disk 820 and a removable optical disk 826, it will be appreciated by those skilled in the art that other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 816, magnetic disk 820, optical disk 826, ROM 810, or RAM 812, including an operating system 830, one or more application programs 832, other program modules 834 and program data 836. Examples of computer operating systems conventionally employed for some types of three-dimensional and/or two-dimensional medical image data include the NUCLEUS® operating system, the LINUX® operating system, and others, for example, providing capability for supporting application programs 832 using, for example, code modules written in the C++® computer programming language.

A user can enter commands and information into computation resource 802 through input devices such as input media 838 (e.g., keyboard/keypad, tactile input or pointing device, mouse, foot-operated switching apparatus, joystick, touchscreen or touchpad, microphone, antenna etc.). Such input devices 838 are coupled to the processing unit 804 through a conventional input/output interface 842 that is, in turn, coupled to the system bus. A monitor 850 or other type of display device is also coupled to the system bus 808 via an interface, such as a video adapter 852.

The computation resource 802 can include capability for operating in a networked environment (as illustrated in FIG. 9, for example) using logical connections to one or more remote computers, such as a remote computer 860. The remote computer 860 can be a personal computer, a server, a router, a network PC, a peer device or other common network node, and typically includes many or all of the elements described above relative to the computation resource 802. In a networked environment, program modules depicted relative to the computation resource 802, or portions thereof, can be stored in a remote memory storage device such as can be associated with the remote computer 860. By way of example, remote application programs 862 reside on a memory device of the remote computer 860. The logical connections represented in FIG. 8 can include interface capabilities, e.g., such as interface capabilities 952 (FIG. 9) a storage area network (SAN, not illustrated in FIG. 8), local area network (LAN) 872 and/or a wide area network (WAN) 874, but can also include other networks.

Such networking environments are commonplace in modern computer systems, and in association with intranets and the Internet. In certain implementations, the computation resource 802 executes an Internet Web browser program (which can optionally be integrated into the operating system 830), such as the “Internet Explorer®” Web browser manufactured and distributed by the Microsoft Corporation of Redmond, Wash.

When used in a LAN-coupled environment, the computation resource 802 communicates with or through the local area network 872 via a network interface or adapter 876. When used in a WAN-coupled environment, the computation resource 802 typically includes interfaces, such as a modem 878, or other apparatus, for establishing communications with or through the WAN 874, such as the Internet. The modem 878, which can be internal or external, is coupled to the system bus 808 via a serial port interface.

In a networked environment, program modules depicted relative to the computation resource 802, or portions thereof, can be stored in remote memory apparatus. It will be appreciated that the network connections shown are exemplary, and other means of establishing a communications link between various computer systems and elements can be used.

A user of a computer can operate in a networked environment 900 using logical connections to one or more remote computers, such as a remote computer 860, which can be a personal computer, a server, a router, a network PC, a peer device or other common network node. Typically, a remote computer 860 includes many or all of the elements described above relative to the computer 800 of FIG. 8.

The computation resource 802 typically includes at least some form of computer-readable media. Computer-readable media can be any available media that can be accessed by the computation resource 802. By way of example, and not limitation, computer-readable media can comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 802.

Communication media typically embodies computer-readable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

The computer 802 can function as one or more of the control segments of module 920 (FIG. 9), the computer 930, the operator console 940 and/or the data acquisition and conditioning module 960, for example, via implementation of the processes in FIGS. 2-5 respectively, as one or more computer program modules. Apparatus components of methods 200-500 can be embodied as computer hardware circuitry or as a computer-readable program, or a combination of both.

More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in general computer environment 800 in FIG. 8, or on at least as many computers as there are components.

FIG. 9 is a diagram of an overview of an X-ray system 900. The system 900 optionally includes a gantry 902 or other support for an illumination source 904, such as an X-ray illumination source, capable of providing illumination 906, such as X-rays or other non-destructive internal imaging illumination, and can optionally include a test subject support 908 that is transmissive with respect to the illumination 906 and that is positioned above a scintillator 909 and detector 910 that is also opposed to the illumination source 904. Alternatively, a direct conversion detector 910 can be employed without need for a scintillator.

In one implementation, components of the system 900 and a test subject 912 are maintained in a defined geometric relationship to one another by the gantry 902. A distance between the illumination source 904 and the detector 910 can be varied, depending on the type of examination sought, and the angle of the illumination 906 respective to the test subject 912 can be adjusted with respect to the body to be imaged responsive to the nature of imaging desired.

In one implementation, the test subject support 908 is configured to support and/or cause controlled motion of the test subject 912, such as a living human or animal patient, or other test subject 912 suitable for non-destructive imaging, above the scintillator 909/detector 910 so that illumination 907 is incident thereon after passing through the test subject 912. In turn, information from the detector array 910 describes internal aspects of the test subject 912.

The scintillator 909 can be a conventional CsI scintillator 909, optically coupled to an array of photodiodes (not illustrated), such as a two-dimensional array of photodiodes and suitable control transistors formed using semiconductor material such as amorphous silicon, or any other form of detector 910 suitable for use with the type or types of illumination 906 being employed, such as X-rays. The detector elements are typically tesselated in a mosaic. The scintillator 909 converts incident photons comprising electromagnetic radiation, such as X-rays, from high-energy, high-frequency photons 907, into lower-energy, lower-frequency photons corresponding to spectral sensitivity of the detector elements, in a fashion somewhat analogous to fluorescence, as is commonly known in the context of many visible-light sources in use today. Alternatively, the detector 910 can be formed as a flat-panel array including amorphous Silicon (a-Si) active elements, together with either a scintillator layer 909, or a direct converter material such as Cadmium Zinc Telluride (CdZnTe), Mercuric Iodide (Hgl₂), Lead Iodide (Pbl₂), or amorphous Selenium (α-Se).

In some modes of operation, such as CT, the gantry 902 and test subject support or table 908 cooperatively engage to move the test subject 912 longitudinally within an opening 914, that is, along an axis 916 extending into and out of the plane of FIG. 9. In some modes of operation, the gantry 902 rotates the X-ray source 904 and detector 910 about the axis 916, while the support 908 moves longitudinally, to provide a helical series of scans of the test subject 912, where a pitch of the helices is defined as a ratio of a longitudinal distance traveled by the table 908 during a complete revolution of the gantry 902, compared to a length of the detector 910 along the axis 916 of linear motion.

The system 900 also optionally includes a control module or controller 920. The controller 920 can include a motor control module 922 configured to move the test subject support 908 and thus the test subject 912 relative to the X-ray source 904 and/or detector 910, and can also control motors in the gantry 902 or to position the X-ray illumination source 904 relative to the test subject 912 and/or the detector 910.

The controller 920 includes a detector controller 924 configured to control elements within the detector 910 and to facilitate data transfer therefrom. The controller 920 also includes a drive parameter controller 928 configured to control electrical drive parameters delivered to the X-ray source 904. One or more computers 930 provide connections to the controller 920 via a bus 932 configured for receiving data descriptive of operating conditions and configurations and for supplying appropriate control signals. Buses 934, 937 and 939 act to transfer data and control signals, for example with respect to a module 935, configured as an image processing engine, via interconnections such as 937, 939 that are configured for exchange of signals and data to and/or from the computer 930 as well as other elements of the system 900 and/or external computation or communications resources (not illustrated in FIG. 9).

The system 900 also includes a bus 936, a bus 938 and an operator console 940. The operator console 940 is coupled to the system 900 through the bus 934. The operator console 940 includes one or more displays 942 and a user input interface 944. The user input interface 944 can include a touchscreen, keyboard, a mouse or other tactile input device, capability for voice commands and/or other input devices. The one or more displays 942 provide video, symbolic and/or audio information relative to operation of system 900, user-selectable options and images descriptive of the test subject 912, and can display a graphical user interface for facilitating user selection among various modes of operation and other system settings.

The image processing engine 935 facilitates automation of accurate measurement and assessment. The image processing engine 935 is capable of forming multiple, coordinated images for display, for example via the monitor 942, to provide the types of depictions described below. The image processing engine 935 can comprise a separate and distinct module, which can include application-specific integrated circuitry, or can comprise one or more processors coupled with suitable computer-readable program modules, or can comprise a portion of the computer 930 or other computation device.

The system 900 also includes memory devices 950, coupled via the bus 936 to the computer 930 through suitable interfaces. Datasets representing three-dimensional data and image or two-dimensional data typically conform to the digital imaging and communications in medicine (DICOM) standard, which is widely adopted for handling, storing, printing, and transmitting information in medical imaging. The DICOM standard includes a file format definition and a network communications protocol. The communication protocol is an application protocol that uses TCP/IP to communicate between systems. DICOM files can be stored in memory devices 950 and retrieved therefrom, and can be exchanged between two entities that are capable of receiving image and patient data in DICOM format.

The memory devices 950 include mass data storage capabilities 954 and one or more removable data storage device ports 956. The one or more removable data storage device ports 956 are adapted to detachably couple to portable data memories 958, which can include optical, magnetic and/or semiconductor memories and can have read and/or write capabilities, and which can be volatile or non-volatile devices or can include a combination of the preceding capabilities.

The system 900 further includes a data acquisition and conditioning module 960 that has data inputs coupled to the detector 910 and that is coupled by the bus 938 to the one or more computers 930. The data acquisition and conditioning module 960 includes analog to digital conversion circuitry for capturing analog data from the detector 910 and then converting those data from the detector 910 into digital form, to be supplied to the one or more computers 930 for ultimate display via one or more of the displays 942 and for potential storage in the mass storage device 954 and/or data exchange with remote facilities (not shown in FIG. 9). The acquired image data can be conditioned in either the data acquisition and conditioning module 960 or the one or more computers 930 or both.

The system 900 also includes a power supply 970, coupled via interconnections represented as a power supply bus 972, shown in dashed outline, to other system elements, and a power supply controller 974. In some implementations, the system 900 is configured to be a mobile system equipped with a portable power supply 970, such as a battery. In other words, the system 900 can comprise a wheeled unit and can be electromotively powered in self-contained fashion, lending physical agility to the ensemble of attributes offered by the system 900.

Volumetric data collected via exposure of the test subject 912 to suitable illumination 906 can be processed via many different types of tools, each intended to enhance some portion of information content described by the data. One result can be inconsistency between analytical results from different types of signal processing tools, or between measurement results corresponding to different measurement times and/or measurement phases.

### Conclusion

A landmark registration system is described. A technical effect of the registration of landmarks without having a fixed order. Although specific implementations have been illustrated and described herein, it will be appreciated by those of ordinary skill in the art that any arrangement which is calculated to achieve the same purpose may be substituted for the specific implementations shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future communication devices, different file systems, and new data types.

The terminology used in this application is meant to include all object-oriented, medical imaging and communication environments and alternate technologies which provide the same functionality as described herein.

We claim:

1. A method to manage landmarks in medical images, the method comprising using a processor to perform:
loading a plurality of three-dimensional images into a memory;
specifying at least one landmark position on one image of the plurality of three-dimensional images in the memory, wherein specifying each of the at least one landmark position further comprises:
receiving into the memory from a user an indication of a position on an image from a graphical user interface;
if no position is defined on the image for a current landmark, then defining the position of the current landmark as the received position and displaying a visual indicator at the row of the image and in the column of the current landmark in a table on the graphical user interface, the table having one row of each of the plurality of three-dimensional images and having one column for each of the at least one landmark; and
if a position is defined for the current landmark on the image, then creating a new landmark in the memory and displaying a visual indicator at the row of the image and in the column of the new landmark in a table on the graphical user interface; and
updating relative positions of the plurality of three-dimensional images in the memory according to each of the at least one landmark position and a specified reference image and a registration image in response to the specification of at least one landmark position.

2. The method of claim 1, wherein receiving from the user an indication of a position on a graphical user interface further comprises
receiving in the memory from the user a position of a mouse pointer or other position indicator over the an image;
receiving in response to an indication from the user in the memory from the user an indication form of a click of a mouse button or a pressed key; and
associating the position of the mouse pointer with the landmark on the image.

3. The method of claim 1 wherein the specifying at least one landmark position and updating relative positions is performed more than once.

4. The method of claim 1, wherein the plurality of three-dimensional images in the memory further comprises:
at least two different modalities.

5. The method of claim 4, wherein the at least two different modalities further comprises:
computed tomography, positron emission tomography, magnetic resonance, X-Ray and single photon emission computed tomography.

6. The method of claim 1, wherein the plurality of three-dimensional images in the memory further comprises:
at least two different acquisition dates.

7. The method of claim 1, wherein the at least one landmark position further comprises:
a metal marker attached to the imaged patient.

8. The method of claim 1, wherein the at least one landmark position further comprises:
an anatomically well-defined point.

9. A computer-accessible medium having executable instructions to managing landmarks in medical images, the executable instructions capable of directing a processor to perform:
loading a plurality of three-dimensional images into a memory;
specifying at least one landmark position on one image of the plurality of three-dimensional images in the memory; and
updating relative positions of the plurality of three-dimensional images in the memory according to each of the at least one landmark position and a specified reference image and a registration image in response to the specification of at least one landmark position.

10. The computer-accessible medium of claim 9, the medium further comprising executable instructions capable of directing the processor to perform more than once the specifying at least one landmark position and updating relative positions.

11. The computer-accessible medium of claim 9, wherein the plurality of three-dimensional images in the memory further comprises:
at least two different modalities.

12. The computer-accessible medium of claim 11, wherein the at least two different modalities further comprises:
computed tomography, positron emission tomography, magnetic resonance, X-Ray and single photon emission computed tomography.

13. The computer-accessible medium of claim 9, wherein the plurality of three-dimensional images in the memory further comprises:
at least two different acquisition dates.

14. The computer-accessible medium of claim 9, wherein the at least one landmark position further comprises:
a metal marker attached to the imaged patient.

15. The computer-accessible medium of claim 9, wherein the at least one landmark position further comprises:
an anatomically well-defined point.

16. The computer-accessible medium of claim 9, wherein the executable instructions capable of directing the processor to specify each of the at least one landmark position further comprise executable instructions capable of directing the processor to perform:
receiving from a user an indication of a position on a graphical user interface;
if no position is defined on the image for the current landmark then defining the position of the current landmark as the received position and displaying a visual indicator at a row of the image and in a column of the current landmark in a table on the graphical user interface, the table having one row of each plurality of three-dimensional images and having one column for each of the at least one landmark; and
if a position is defined for the current landmark on the image, then creating a new landmark in the memory and displaying a visual indicator at the row of the image and in the column of the new landmark in a table on the graphical user interface; and

17. The computer-accessible medium of claim 16, wherein the executable instructions capable of directing the processor to receive from the user an indication of a position on a graphical user interface further comprise executable instructions capable of directing the processor to perform:
receiving from the user a position of a mouse pointer or other position indicator over the image;
receiving an image in response to an indication from the user an indication in the form of a click of a mouse button or a pressed key; and
associating the position of the mouse pointer with the landmark on the image.

18. A method to manage landmarks in medical images, the method comprising using a processor to perform:
receiving an indication of a position on a graphical user interface;
displaying a table on the graphical user interface, the table having one row of each of a plurality of three-dimensional images and having one column for each of a plurality of landmarks and having a visual indicator at a row of a particular image of the plurality of three-dimensional images and in the column of a particular landmark of the plurality of landmarks.

19. The method of claim 18, wherein the visual indicator further comprises:
a check mark.

20. The method of claim 18, further comprising:
updating at least one visual indicator in the table display on the graphical user interface at a row of a particular image of the plurality of three-dimensional images and in the column of a particular landmark of the plurality of landmarks
